(19) United States
(12) Patent Application Publication
(10) Pub. No.: US 2019/0119520 A1
(43) Pub. Date: Apr. 25, 2019

(54) THERMALLY EMISSIVE COATING MATERIAL COMPOSITION, THERMALLY EMISSIVE COATING AND COATING FORMING METHOD

(71) Applicant: HONDA MOTOR CO., LTD., Tokyo (JP)

(72) Inventors: Kazutaka YOKOYAMA, Wako-shi (JP); Ryosuke KODAIRA, Wako-shi (JP); Kosuke DATEKI, Wako-shi (JP); Takanori KOBAYASHI, Wako-shi (JP)

(21) Appl. No.: 16/155,200

(22) Filed: Oct. 9, 2018

(30) Foreign Application Priority Data
Oct. 20, 2017 (JP) 2017-203110

(51) Int. Cl. C09D 123/06; C09D 7/61; C09D 7/80

(52) U.S. Cl. CPC C09D 123/06; C08K 5/5419; C09D 7/80; C09D 7/61

(57) ABSTRACT

Provided are a thermally emissive coating material composition, a thermally emissive coating and a coating forming method without any thermally emissive filler. Such a thermally emissive coating material composition includes a poly-α-olefin having a side chain with 5 to 20 carbon atoms and a silane coupling agent. The side chain preferably includes 10 to 15 carbon atoms. The thermally emissive coating material composition forms a thermally emissive coating on a surface of a base material.

### TECHNICAL FIELD

The present invention relates to a thermally emissive coating formed on a surface of a base material to promote heat release, a thermally emissive coating material composition included in the thermally emissive coating and a coating forming method therefor.

### BACKGROUND ART

To form a thermally emissive coating on a surface of an apparatus to promote heat release from the apparatus is publicly known. Such a thermally emissive coating generally includes a main material comprised primarily of a resin such as acrylic resin, and a thermally emissive filler included in the main material, the filler being comprised primarily of inorganic particles such as carbon black held in the main material. See (Patent Document 1).

### PRIOR ART DOCUMENT (S)

### Patent Document(s)

Patent Document 1: JP2006-281514A

### SUMMARY OF THE INVENTION

### Task to be Accomplished by the Invention

A thermally emissive coating in the prior art includes a thermally emissive filler as an essential component. This means that it is necessary to select a thermally emissive filler suitable for a main material, prepare the thermally emissive fillers, and disperse the thermally emissive fillers in the main material, and other necessary processes. Some thermally emissive fillers inconveniently promote the deterioration of the main material. If any thermally emissive filler is not used, forming coating would become easier.

The present invention has been made in view of the aforementioned problems of the prior art, and a primary object of the present invention is to provide a thermally emissive coating material composition, a thermally emissive coating and a coating forming method without any thermally emissive filler.

### Means to Accomplish the Task

In order to attain the above object, a first aspect of the present invention provides a thermally emissive coating material composition for forming a thermally emissive coating, wherein the thermally emissive coating material composition comprises a poly-α-olefin having a structure represented by the following chemical formula (1) and a silane coupling agent,

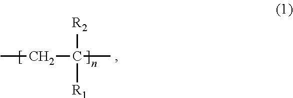

where R₁ is hydrogen or a methyl group, and R₂ is a straight alkyl with 5 to 20 carbon atoms.

This aspect of the present invention makes it possible to provide a thermally emissive coating material composition without any thermally emissive filler. In the composition, a straight alkyl is flexible enough to be capable of having various conformations. Thus, molecular motions including rotational or vibrational motions of a straight alkyl side chain increase the energy consumption therein and also increase contacts between the side chain and external gas molecules and/or liquid molecules, thereby promoting and improving heat release of a thermally emissive coating.

In the above aspect, the thermally emissive coating material composition preferably contains the silane coupling agent in an amount of 1 to 10% by weight of a sum of the poly-α-olefin and the silane coupling agent.

This feature can increase the reaction rate between the poly-α-olefin and the silane coupling agent.

In the above aspect, R₂ in the chemical formula (1) is preferably a straight alkyl with 10 to 15 carbon atoms.

This feature can improve the thermal emissivity of the thermally emissive coating.

Another aspect of the present invention provides a thermally emissive coating comprising the thermally emissive coating material composition of the above aspect, and formed on a surface of a base material.

This aspect of the present invention makes it possible to provide a thermally emissive coating without any thermally emissive filler.

In the above aspect, the thermally emissive coating preferably has a thickness of 15 to 50 μm.

This feature can improve the thermal emissivity of the thermally emissive coating. In the thermally emissive coating, most of the heat release occurs via the straight alkyl side chains located in a surface portion of the thermally emissive coating. Thus, the greater the ratio of the surface area to the volume of the thermally emissive coating has, the greater the thermal emissivity thereof becomes.

In the above aspect, the base material preferably includes aluminum.

This feature enables the thermally emissive coating to be adhered to the base material in a stable manner

In the above aspects, the thermally emissive coating preferably includes a thermally emissive filler formed of inorganic particles in an amount of 0.1% by weight or less. Also, preferably, the thermally emissive coating is free of any thermally emissive filler formed of inorganic particles.

This feature can improve the thermal emissivity of the thermally emissive coating. The thermally emissive fillers located in a surface portion can prevent molecular motions of the straight alkyl side chains, which leads to a decrease in the thermal emissivity of the thermally emissive coating.

Yet another aspect of the present invention provides a coating forming method for forming a thermally emissive coating on a base material comprising: a first step of applying a solution containing a poly-α-olefin having a structure represented by the following chemical formula (1) and a silane coupling agent; and a second step of heating the base material, on which the solution has been applied, at 100° C. to 150° C. subsequent to the first step,

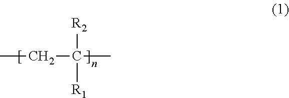

where R₁ is hydrogen or a methyl group, and R₂ is a straight alkyl with 5 to 20 carbon atoms.

### Effect of the Invention

As can be appreciated from the foregoing, the present invention can provide a thermally emissive coating material composition, a thermally emissive coating and a coating forming method without any thermally emissive filler.

### BRIEF DESCRIPTION OF THE DRAWINGS

FIG. 1 is a diagram of a test container used for thermal emissivity testing;

FIG. 2A is a graph showing the relationship between heat release time and temperature;

FIG. 2B is a graph showing the relationship between heat release time and temperature difference (ln(Ts−Ta));

FIG. 3 is a graph showing the relationship between the thickness of a thermally emissive coating and the heat release rate ratio; and

FIG. 4 is a graph showing the relationship between the number of carbon atoms of a side chain and the heat release rate ratio.

### DESCRIPTION OF THE PREFERRED EMBODIMENT(S)

Embodiments of a thermally emissive coating material composition, a thermally emissive coating and a coating forming method therefor according to the present invention are described in the following.

(Thermally Emissive Coating Material Composition)

A thermally emissive coating material composition is a composition included in a thermally emissive coating, and contains a poly-α-olefin having a structure represented by the following chemical formula (1) and a silane coupling agent,

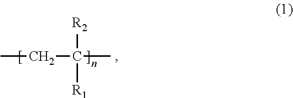

where R₁ is hydrogen or a methyl group, and R₂ is a straight alkyl with 5 to 20 carbon atoms.

The poly-α-olefin having the structure represented by the chemical formula (1) can be produced by the polymerization reaction of α-olefins having 7 to 22 carbon atoms. By using an a-olefin having a methyl group side chain at the β position, it is possible to produce a poly-α-olefin having a structure represented by the chemical formula (1) in which R₁ is a methyl group.

The silane coupling agent has a structure represented by a general formula X—Si—Y₃, where X is an organic group and Y is an alkoxy group with 1 to 3 carbon atoms. Examples of the organic group include a vinyl group, an epoxy group, a methacryl group, an acryl group, an amino group, and a mercapto group. Examples of the alkoxy group include a methoxy group, an ethoxy group, a dimethoxy group, and a diethoxy group. An alkylene group with 1 to 6 carbon atoms may be interposed between X and Si. In some cases, one alkoxy group in Y may be changed to a methyl group. Examples of the silane coupling agent includes vinyl trimethoxysilane, vinyl triethoxysilane, 2-(3,4-epoxycyclohexyl) ethoxysilane, 3-glycidoxypropylmethyldimethoxysilane, 3-glycidoxypropyltrimethoxysilane, 3-glycidoxypropylmethyldiethoxysilane, 3-glycidoxypropyltriethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, 3-acryloxypropyltrimethoxysilane, N-2-(aminoethyl)-3-aminopropylmethyldimethoxysilane, N-2-(aminoethyl)-3-aminopropyltrimethoxysilane, 3-aminopropyltrimethoxysilane, 3-aminopropyltriethoxysilane, 3-triethoxysilyl-N-(1,3-dimethyl-butylidene) propylamine, N-phenyl-3-aminopropyltrimethoxysilane, 3-mercaptopropylmethyldimethoxysilane, and 3-mercaptopropyltrimethoxy silane.

The content of the silane coupling agent is 1 to 10% by weight, preferably 1 to 5% by weight of a sum of the poly-α-olefin and the silane coupling agent. In cases where the silane coupling agent was vinyltrimethoxysilane, R₁ of the poly-α-olefin was hydrogen, and R₂ was a linear alkyl group with 5 to 20 carbon atoms, when the content of the silane coupling agent was 5 to 10% by weight, the reaction rate between the poly-α-olefin and the silane coupling agent was 90% or more, and when the content of the silane coupling agent was 1 to 4% by weight, the reaction rate between the poly-α-olefin and the silane coupling agent was 98% or more.

(Thermally Emissive Coating Material)

A thermally emissive coating material includes the thermally emissive coating material composition containing a poly-α-olefin and a silane coupling agent as described above and a solvent which dissolves the thermally emissive coating material composition, and is prepared in a liquid form. The solvent is preferably a volatile organic solvent, and non-limiting examples of the solvent include: ketones such as acetone and methyl ethyl ketone; ester acetates such as methyl acetate, ethyl acetate, and propyl acetate; carbon hydrides such as n-hexane, cyclohexane, methylcyclohexane and n-heptane; aromatic hydrocarbons such as toluene, xylene, and benzene; and ethers such as ethyleneglycol monobutyl ether, ethylene glycol monophenyl ether, and ethylene glycol dimethyl ether. The thermally emissive coating material may further contain other ingredients such as pigments, pigment dispersants, leveling agents, antifoaming agents, and thickening agents.

(Thermally Emissive Coating)

A thermally emissive coating is a coating formed on a surface of a base material and includes the above-described thermally emissive coating material composition. The base material may be a housing, a tube or a core of a heat exchanger, for example. In this case, the heat exchanger may be, for example, an intercooler or a radiator of a vehicle. The base material is preferably formed of iron, aluminum, or alloys thereof.

In the thermally emissive coating, a poly-α-olefin having the structure represented by the chemical formula (1) is bonded to a base material via a silane coupling agent. The silane coupling agent is bonded to the base material through hydrolysis which changes its alkoxy group to a hydroxyl group, which, in turn, forms a hydrogen bond with a hydroxyl group on a surface of iron or aluminum. The silane coupling agent binds to the poly-α-olefin at its organic group. For example, the silane coupling agent is substituted for R₂ in the chemical formula (1), and binds to a carbon in the main chain of the poly-α-olefin at its organic group. Preferably, the thermally emissive coating has a thickness of 15 μm to 50 μm.

The thermally emissive coating includes a thermally emissive filler formed of inorganic particles in an amount to 0.1% by weight or less. Preferably, the thermally emissive coating is free of any thermally emissive filler formed of inorganic particles. The thermally emissive filler may be formed of particles of a filler material such as carbon black, zinc oxide, aluminum nitride, silicon oxide, calcium fluoride, boron nitride, quartz, kaolin, aluminum hydroxide, bentonite, talc, salicide, forsterite, mica, cordierite, or boron nitride.

The poly-α-olefin forming the thermally emissive coating has a straight alkyl side chain, which is flexible enough to be capable of having various conformations. Thus, it is considered that molecular motions including rotational or vibrational motions of a side chain increase the energy consumption therein and also increase contacts between the side chain and external gas molecules and/or liquid molecules, thereby improving the thermal emissivity of a thermally emissive coating. The side chain is preferably a straight alkyl due to the ease of molecular motions. It is considered that, when a side change includes a polar group, a double bond, a triple bond or some other types of groups or bonds, molecular motions of the side chain are prevented, leading to a decrease in the thermal emissivity of a thermally emissive coating.

(Coating Forming Method)

A first coating forming method includes the first step of applying the above-described thermally emissive coating material to a surface of a base material. Methods of applying include spraying, dipping coating, brush coating, roller coating and any other suitable application technique. The first coating forming method further includes the next step of heating the base material with the thermally emissive coating material applied thereon at 100 to 150° C. for 20 to 40 minutes. This step causes the poly-α-olefin to be bonded to the surface of the base material via the silane coupling agent, and allows the solvent to volatilize. As a result, the thermally emissive coating is formed on the surface of base material.

### EXAMPLES

### Example of Coating Forming Method

Several thermally emissive coating material compositions were prepared where the compositions have the structure represented by the chemical formula (1) where R₁ was hydrogen and R₂ were alkyls with different numbers of carbon atoms. Vinyltrimethoxysilane was used as a silane coupling agent. Each poly-α-olefin and the silane coupling agent were diluted with ethyleneglycol monobutyl ether to produce a corresponding thermally emissive coating material. The content of the silane coupling agent was 5% by weight of a sum of each poly-α-olefin and the silane coupling agent. The sum concentration of each poly-α-olefin and the silane coupling agent was 5% by weight of the ethyleneglycol monobutyl ether. As a substrate (base material), an aluminum plate (A1050, 150 mm length, 70 mm width and 0 8 mm thickness) was used. Each thermally emissive coating material was applied to a major surface of the substrate by air-spraying a proper amount of the thermally emissive coating material onto the surface of the substrate. Then, in a heating oven, the substrate with the applied thermally emissive coating material was heated at 120° C. for 30 minutes. This heating step caused each poly-α-olefin to be bended to the surface of the substrate via the silane coupling agent, and also caused ethyleneglycol monobutyl ether to volatilize, thereby forming a thermally emissive coating on the surface of the substrate. The thickness of a thermally emissive coating measured after heating was determined as the thickness of the thermally emissive coating. The thickness of a thermally emissive coating can be adjusted by the quantity of thermally emissive coating material to be air-sprayed.

(Thermal Emissivity Testing)

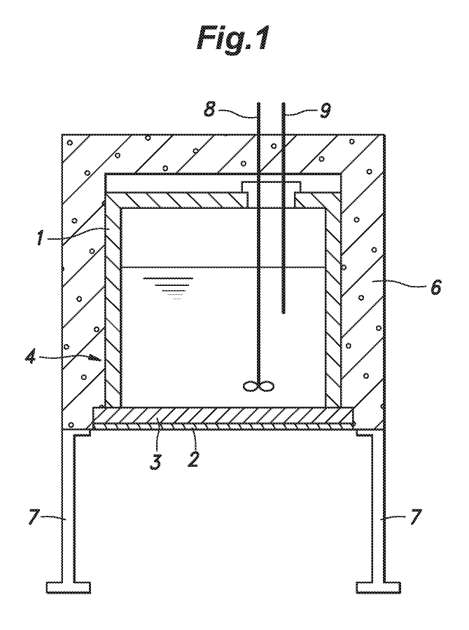

The thermal emissivity of each thermally emissive coating was assessed by the following thermal emissivity testing. As shown in FIG. 1, the bottom portion of a rectangular parallelepiped steel can 1 (130 mm length, 50 mm width, 100 mm height and thickness 0.8 mm) was blocked with a substrate 3 with a thermally emissive coating 2 formed thereon so as to form a test container 4. The substrate 3 was provided such that the surface with the thermally emissive coating 2 faces downward (to the outside). The steel can 1 and the substrate 3 were liquid-tightly bonded to each other with an adhesive. The top and the sides of the test container 4 are covered with foamed polystyrene 6 (heat insulating material) having a thickness of 30 mm. The test container 4 was placed on a container stand 7 with the foamed polystyrene 6 provided therebetween, and the substrate 3 was placed far enough away from those other elements. A liquid inlet is formed at the top of the test container 4. At the beginning of a testing process, 350 mL engine oil heated to 100° C. was injected into the test container 4. The injected engine oil was stirred at 200 rpm with a stir bar 8 which was provided inside the test container. Furthermore, a thermocouple 9 for measuring the temperature of the engine oil was also provided within the test container 4. A thermocouple (not shown) for measuring outside air temperatures is provided outside a measuring apparatus (outside the foamed polystyrene). Measurements were conducted in an environment in which the outside air temperature was at room temperature (about 22° C.), and when the temperature of the injected engine oil dropped from 100° C. to reach 85° C., the time was defined as time zero, from which temperatures of the engine oil were measured and recorded. As a reference, similar thermal emissivity testing (temperature measurements) was conducted using a test container with a bottom without any thermally emissive coating.

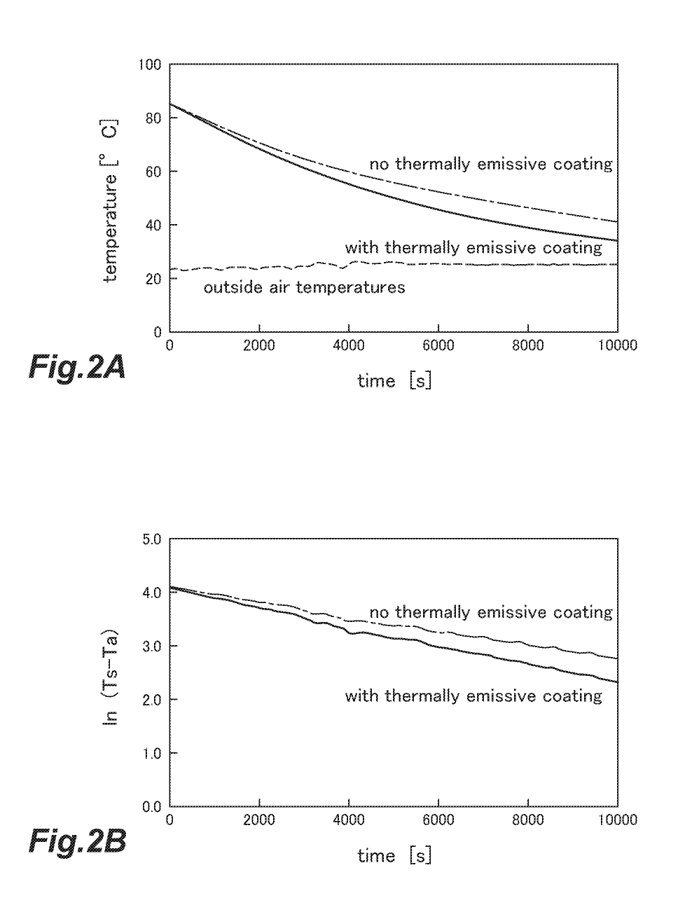

FIGS. 2A and 2B show the obtained results of the thermal emissivity testing. FIGS. 2A and 2B show the results obtained under the conditions in which the poly-α-olefins had the structure represented by the chemical formula (1) where R₁ was hydrogen and R₂ was alkyls with 13 carbon atoms, and the thickness of the thermally emissive coating was 20 μm. FIG. 2A shows a graph including a horizontal axis represents time [s] and a vertical axis represents temperatures [° C.]. The temperature of engine oil decreases due to heat release via the substrate as time proceeds. FIG. 2B shows a graph showing the converted results shown in FIG. 2A, and in the graph of FIG. 2B, a horizontal axis represents time [s] and a vertical axis represents (ln (Ts−Ta); that is, the natural log of value obtained by subtracting a corresponding outside air temperature Ta from an engine oil temperature Ts. As can be seen in FIGS. 2A and 2B, it was confirmed that, when the bottom substrate was provided with the thermally emissive coating, the gradient in the graph was larger compared to the case of the bottom substrate without the thermally emissive coating (reference testing). Here, the gradient in the graph in FIG. 2B, that is, the amount of change of In (Ts−Ta) per unit time (1 s) is defined as a heat release rate Vs, Vr. Vs represents a heat release rate for the substrate provided with the thermally emissive coating and Vr represents a heat release rate for the substrate without a thermally emissive coating. The ratio of a heat release rate Vs to a heat release rate Vr (reference testing) is defined as a heat release rate ratio R (=(Vs−Vr)/Vr×100).

(Effect of Coating Thickness on Thermal Emissivity)

Poly-α-olefins having the structure represented by the chemical formula (1) where R₁ was hydrogen and R₂ was alkyls with 13 carbon atoms was used to prepare several thermally emissive coatings having different thicknesses by spraying different quantities of the thermally emissive coating material onto substrates. The thicknesses of the formed thermally emissive coatings were 15 μm, 45 μm, and 78 μm. The thermal emissivity testing was conducted on each of the substrates with the respective thermally emissive coatings having their different thicknesses.

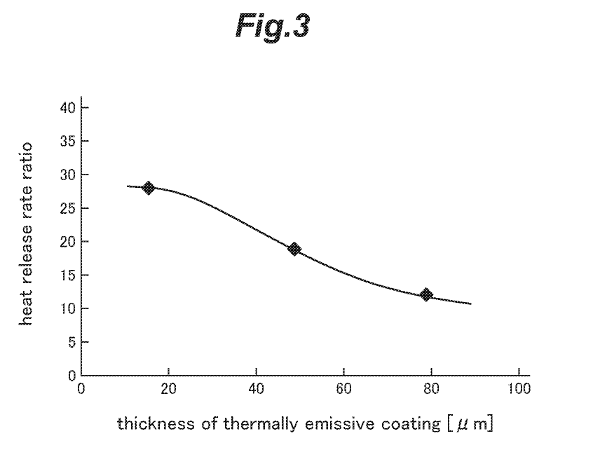

FIG. 3 shows a graph showing the relationship between the thickness and the heat release rate ratio of a thermally emissive coating. From the results shown in FIG. 3, it was confirmed that, as the thickness of the thermally emissive coating increased, the heat release rate ratio decreased. It was also confirmed that the heat release rate ratio varied little when the thickness of the thermally emissive coating was in the range above 80 μm. In the case of the thermally emissive coating of this example, it was difficult to form a uniform coating when the thickness of the coating was 10 μm or less. Also, the thermally emissive coating desirably has a thickness of at least 10 μm since the heat release rate ratio becomes zero when the thickness of the thermally emissive coating is zero. Preferably, the thickness of the thermally emissive coating is 15 to 50 μm. Since, within this thickness range, the thermal emissivity increases as the film thickness is thinner, the thickness of the thermally emissive coating is more preferably 15 to 40 μm, and further more preferably 15 to 30 μm. The thinner the thermally emissive coating is, the greater the ratio of the surface area to the volume of the thermally emissive coating is, which means more straight alkyl side chains are placed in the surface of the thermally emissive coating with regard to the volume. It is considered that this is how an increase in the thermal emissivity occurs.

(Effect of Side Chain on Thermal Emissivity)

Poly-α-olefins having the structure represented by the chemical formula (1) where R₁ was hydrogen and R₂ was alkyls with 8, 13, and 17 carbon atoms were used to prepare respective thermally emissive coatings each having a thickness of 20 μm. The thermal emissivity testing was conducted on each of the substrates with the respective thermally emissive coatings.

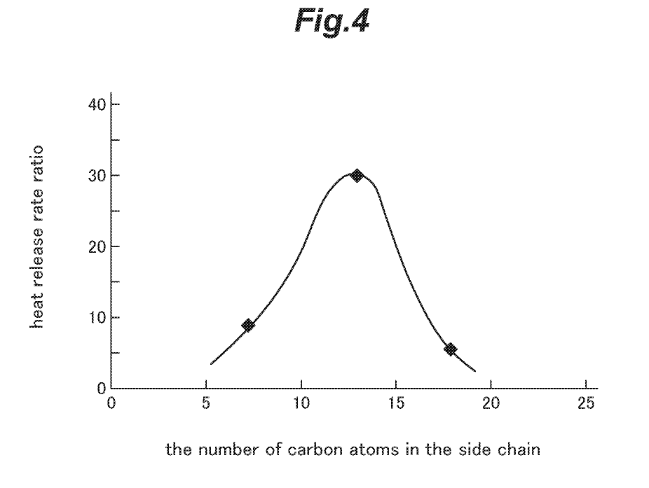

FIG. 4 shows a graph showing the relationship between the number of carbon atoms of a side chain and the heat release rate ratio of a thermally emissive coating. From the results shown in FIG. 4, it was confirmed that, in any case where the number of carbon atoms of the straight chain alkyl group (the number of carbon atoms in the side chain) was 8, 13 or 17, the heat release rate ratio was greater than 0 and the thermal emissivity was improved as compared with the case where the thermally emissive coating was not provided. It was also confirmed from an approximate curve obtained from the results in FIG. 4 that, when the number of carbons of the side chain was 5 to 20, the heat release rate ratio was greater than 0 and the thermal emissivity was improved by a thermally emissive coating. Moreover, it was confirmed that the heat release rate ratio was maximized when the number of carbon atoms of the straight chain alkyl group (the number of carbon atoms in the side chain) was 10 to 15. Accordingly, the number of carbon atoms in the side chain is preferably in the range of 10 to 15.

(Effect of Thermally Emissive Filler on Thermal Emissivity of Thermally Emissive Coating)

A poly-α-olefin having the structure represented by the chemical formula (1) where R₂ was alkyls with 13 carbon atoms was used to prepare a thermally emissive coating material of this example In addition, a thermally emissive coating material of a comparative example was prepared by suspending carbon black (particle size 3 μm) as a thermally emissive filler at a concentration of 0.5% by weight. The thermally emissive coating material of the comparative example was the same as the thermally emissive coating material of the example except that it included a thermally emissive filler. The thermally emissive coating materials of the example and the comparative example were used to prepare respective thermally emissive coatings both having a thickness of 20 μm. The thermal emissivity testing was conducted on each of the substrates with the thermally emissive coatings of the example and the comparative example, respectively.

The results of thermal emissivity testing confirmed that the thermally emissive coating (without any thermally emissive filler) of the example had a higher thermal emissivity than the thermally emissive coating (with the thermally emissive filler) of the comparative example. It is considered that the density of straight alkyl side chains in a surface portion of the thermally emissive coating decreased due to the exposure of the thermally emissive filler to the surface. It is also considered that the thermally emissive filler prevented molecular motions of side chains consisting of a straight alkyl in the surface portion of the thermally emissive coating. As a result, the thermally emissive coating without any thermally emissive filler exhibited the increased thermal emissivity compared to the thermally emissive coating including the thermally emissive filler.

### GLOSSARY

1 steel can
2 thermally emissive coating
3 substrate
4 test container
5 foamed polystyrene
7 container stand
8 stir bar
9 thermocouple

1. A thermally emissive coating material composition for forming a thermally emissive coating, wherein the thermally emissive coating material composition comprises a poly-α-olefin having a structure represented by the following chemical formula (1) and a silane coupling agent, 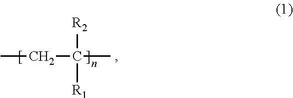
where R₁ is hydrogen or a methyl group, and R₂ is a straight alkyl with 5 to 20 carbon atoms.

2. The thermally emissive coating material composition according to claim 1, wherein the thermally emissive coating material composition contains the silane coupling agent in an amount of 1 to 10% by weight of a sum of the poly-α-olefin and the silane coupling agent.

3. The thermally emissive coating material composition according to claim 1, wherein R₂ in the chemical formula (1) is a straight alkyl with 10 to 15 carbon atoms.

4. A thermally emissive coating comprising the thermally emissive coating material composition according to claim 1, and formed on a surface of a base material.

5. The thermally emissive coating according to claim 4, wherein the thermally emissive coating has a thickness of 15 to 50 μm.

6. The thermally emissive coating according to claim 4, wherein the base material includes aluminum.

7. The thermally emissive coating according to claim 4, wherein the thermally emissive coating comprises a thermally emissive filler formed of inorganic particles in an amount of 0.1% by weight or less.

8. The thermally emissive coating according to claim 4, wherein the thermally emissive coating is free of any thermally emissive filler formed of inorganic particles.

9. A coating forming method for forming a thermally emissive coating on a base material comprising:
a first step of applying a solution containing a poly-α-olefin having a structure represented by the following chemical formula (1) and a silane coupling agent; and
a second step of heating the base material, on which the solution has been applied, at 100° C. to 150° C. subsequent to the first step, 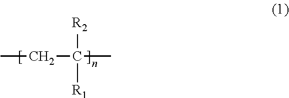
where R₁ is hydrogen or a methyl group, and R₂ is a straight alkyl with 5 to 20 carbon atoms.
